(19) United States
(12) Patent Application Publication
(10) Pub. No.: US 2006/0247963 A1
(43) Pub. Date: Nov. 2, 2006

(54) System and method for designating a facility and promoting a designated facility as ready for cardiac emergencies

(75) Inventors: Matthew Barrer, Wyomissing, PA (US); Norman L. Norris, Birchrunville, PA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: AED Patent Holdings LLC, Birchrunville, PA (US)

(21) Appl. No.: 11/437,576

(22) Filed: May 19, 2006

Related U.S. Application Data
(63) Continuation-in-part of application No. 10/734,220, filed on Dec. 15, 2003.
Application No. 10/734,220 is a continuation of application No. 09/924,503, filed on Aug. 9, 2001, now Pat. No. 6,694,299.
(60) Provisional application No. 60/255,062, filed on Dec. 14, 2000.

(51) Int. Cl. G06F 9/46

(52) U.S. Cl. 705/8

(57) ABSTRACT

There is disclosed a system and method for offering to designate a facility as having a designated cardiac emergency readiness (CER) program, for designating the facility's CER program, and for promoting the facility as having a designated CER program. The designation serves as an indication that the facility has satisfied requirements for providing cardiac emergency care to a user of the facility experiencing cardiac arrest.

### RELATED APPLICATIONS

This is a continuation-in-part of U.S. patent application Ser. No. 10/734,220 filed Dec. 15, 2003, which is a continuation of U.S. patent application Ser. No. 09/924,503 filed Aug. 9, 2001, containing the subject matter of U.S. provisional application No. 60/255,062 filed Dec. 14, 2000, which issued as U.S. Pat. No. 6,694,299 on Feb. 17, 2004, all of which are incorporated herein by reference.

### FIELD OF ENDEAVOR

The present invention relates generally to a method for certifying, or otherwise designating, a facility as being equipped with automatic external defibrillators (“AEDs”) and as having implemented a cardiac emergency readiness (“CER”) program for assisting victims of sudden cardiac arrest in accordance with certain standards. The present invention also relates generally to the promotion of a facility so designated.

### BACKGROUND

Sudden cardiac arrest (“SCA”) is a serious problem and, without immediate and proper treatment, usually results in death. In order to prevent some of these deaths, organizations have trained their staff in cardiopulmonary resuscitation (“CPR”) to provide aid to those suffering SCA (i.e., a heart attack). However, CPR saves lives in less than 5% of these situations. Furthermore, after 4-6 minutes, irreversible damage or death can occur and studies show that, by the time paramedics arrive, it is often too late to resuscitate most SCA victims. After that that time, the odds of resuscitating a SCA victim or of obtaining some other favorable outcome, is greatly diminished, with the chances of survival reduced 7-10% per minute.

As a result, many organizations are now addressing the issue of SCA by purchasing AEDs. However, these devices are frequently located haphazardly at an organization's facility, and without any meaningful guidance as to the appropriate number and location for the particular facility. In addition, although one or more persons who work in/at the facility may have been trained in the use of the AEDs, there may be no program in place to ensure that an adequate number of people have been trained, that they have received the correct training, or that their training is up to date. There may be federal, state and/or local laws and/or regulations involving the training of personnel to use the AEDs, of which the facilities manager is unaware. There may also be no program in place to ensure that the AEDs are regularly maintained, e.g., to be sure that the pads are not out of date, that the batteries are fresh and fully charged, etc.

### SUMMARY OF DISCLOSURE

There is disclosed a method of providing a CER program at a facility that comprises conducting a survey of the facility for determining the proper placement of at least one AED so as to assure, as best as possible, proximity to a possible victim of SCA. The method further comprises the steps of certifying, or otherwise designating, that the CER program has met certain minimum requirements, including proper placement of the AED(s) in accordance with the survey, and providing ongoing support for the CER program, including promoting the facility, through a communications network, as having received the CER designation.

The survey may be conducted by a third party or by facility personnel. If performed by facility personnel, the survey may be conducted after receiving standards for achieving a CER designation that have been transmitted from a facilitator. After the facility personnel have completed the survey and transmitted to the facilitator confirmation that the necessary standards for achieving a CER designation have been met by the facility (including proper placement of AEDs at the facility), the facilitator may transmit confirmation of the designation to the facility.

The facilitator may be an entity used by an event or meeting planner (or other interested member of the public) to aid in locating and/or booking venues for events. Such facilitators may have contacts with both those who plan events, and facilities of the type the planner requires. The facilitator's job is to assist the planner in locating the correct facility for the event, to assist the various competing facilities in promoting their availability, and to assist both in their respective booking efforts. The facilitator may also advertise to the facilities the availability of a certification or other designation for a CER program, and extend offers to the facilities to become certified or otherwise designated, whereby the facility, after undertaking appropriate measures and/or confirmations mandated by a designating entity, becomes a designated facility, i.e., one having a designated, or certified, CER program. The facilitator thereafter promotes the facility as having a designated, or certified, CER program in its advertising and promotional materials for the facility, so that the planners seeking to book an event are able to readily identify those facilities that are designated or certified. In one disclosed embodiment, the facilitator operates a web site that is used by planners to locate facilities for possible booking, and the facilities having designated, or certified, CER programs are identified as such on the web site. In another disclosed embodiment, the facilitator and the designating entity are separate entities and both entities may maintain web sites identifying facilities having designated, or certified, CER programs. Alternatively, the facilitator and the designating entity may be the same entity.

### BRIEF DESCRIPTION OF THE DRAWINGS

FIG. 1 is a flow chart depicting steps that may be employed to implement a CER program.

FIG. 2 is a block diagram depicting the various entities that may be involved in the offer to a facility to become designated, or certified, as having a CER program, the designation, or certification, process, and the promotion of a designated, or certified, facility.

FIG. 3 is a block diagram illustrating certain electronic and non-electronic media that may be used by the entities involved in the designation, or certification, offer to a facility, the designation, or certification, process, and the promotion of a designated, or certified, facility.

FIGS. 4a and 4b are a flow chart illustrating the steps that may be employed in the designation, or certification, offer to a facility, the designation, or certification, process, and the promotion of a designated, or certified, facility.

FIG. 5 is an exemplary checklist that may be used for the designation, or certification, process.

### DETAILED DESCRIPTION OF THE DISCLOSED EMBODIMENTS

The term “facility” as used herein includes any location where emergency medical services cannot be on location within 4-6 minutes of a sudden cardiac arrest and would therefore benefit from implementing a CER program. By way of example, the term facility
includes, but is not limited to:
Shopping malls, including the individual retail establishments located therein as well as stand alone retail establishments not part of a shopping mall;
Golf courses, including buildings and grounds;
Hotels, including inns, motels, time share units and other facilities with overnight accommodations generally considered part of the “Hospitality Industry”;
Sporting venues, including arenas and stadiums;
Concert venues, including auditoriums and halls as well as arenas and stadiums that may also used for sporting events;
Health clubs, including gyms and other facilities catering to exercise and physical fitness;
Business complexes, including office buildings with or without hotels, retail, housing or retail establishments;
Industrial and manufacturing facilities, including research facilities;
Airports and other transportation hubs, including train and bus stations;
Amusement parks, including fairgrounds;
Ski resorts, including buildings and grounds;
Convention halls and conference centers and other meeting facilities considered part of the “Hospitality Industry”;
Educational facilities, including schools, colleges, universities and training centers;
Transportation systems and venues, including trains, cars, buses, airplanes, boats, cruise ships, etc.; and/or,
Apartment and condominium housing complexes, including public and private housing complexes.

The term “designated cardiac emergency ready facility” (DCERF) is used herein to refer to both a facility that has been certified, or otherwise designated, as herein described, and to a facility's designated or certified CER program.

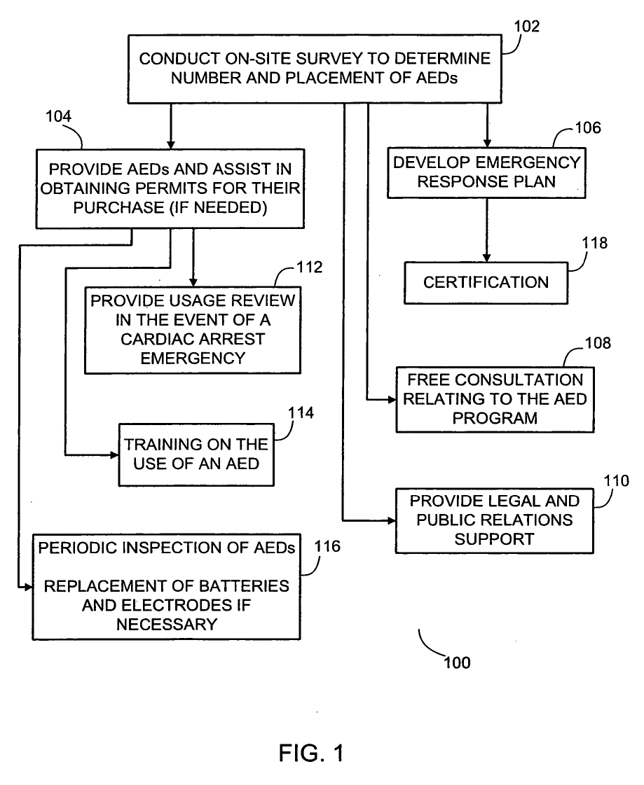

FIG. 1 depicts a method 100 for implementing and maintaining a comprehensive CER program, starting from the initial purchase of AEDs and extending to various facets of the supporting program, including public relations support and legal support. Initially, the method calls for conducting a site survey 102 of the facility to determine the need for AEDs, and if appropriate, the number of AEDs and optimal placement of each AED on or in the facility. It is generally recommended that AEDs be placed within a three-minute response time to any location since irreversible damage can occur after that time period.

Most states require medical direction or a prescription for the purchase and use of an AED, although some AED's are now available without a prescription. The method helps an individual or institution handle the medical authorization process 104, where required, by assisting in obtaining all of the necessary state and local permits for the purchase and use of the AED.

The method then develops a customized emergency response plan 106 that specifies how to deal with incidents of SCA. The plan includes contacting local emergency personnel to familiarize them with the CER program. The plan provides details, such as who should contact an emergency medical specialist (“EMS”), who is qualified to use the AED, and who should meet the ambulance.

The method provides training 114 to the personnel who will use the AED. The training is offered by instructors from the program or though certified instructors from various other organizations such as the American Heart Association® or American Red Cross®.

After the AEDs are in place, the method provides periodic inspections 116 to ensure that the AEDs are operational and accessible and that trained personnel are stationed nearby. The inspections of the AED will check its overall condition, including the electrodes and batteries. An employee of a third party certifier may contact a designated person at the facility on a periodic basis to ensure the AEDs have been inspected and trained personnel are available.

The method also provides replacement of all supplies needed for the operation of the AEDs, including its electrodes and batteries 116. The supplies are provided either free or at cost depending on the nature of the CER program. The electrodes usually have a shelf life, unopened, of approximately two years and are replaced if found to be defective or worn. Similarly, if a battery fails or becomes worn, a replacement battery is provided.

In the event of a SCA or other emergency, the method provides an AED usage review 112 to ensure that it has functioned properly and is still in working condition. As part of the review, the method may also provide an evaluation of the emergency to help improve the response of personnel involved. The evaluation would include, in part, analyzing the performance of the personnel participating in the CER program, the adequacy of the training, the procedures used during the emergency, and the placement of the AEDs. Additionally, counseling may be provided to victims and their families to help cope with the emotional trauma of the event.

The method also provides various other support services, such as assisting in the development of a public relations and legal support plan 110. The public relations plan is aimed at generating goodwill towards the individual or facility implementing the CER program. It includes preparing a public relations announcement informing the public of the CER program. It provides guidance in recruiting volunteers to participate in the program and guidance on preparing newsletters discussing the CER program and other general health related information.

The method also provides legal advice and information to help limit the liability of the individual or facility and to ensure that they are in compliance with all legal requirements associated with the CER program, and in particular the use of the AEDs. For example, information on local “Good Samaritan” laws that limit the liability of persons rendering assistance to injured victims, and laws relating to the technical requirements of the AEDs and persons qualified to use the AEDs are provided. However, in the event that a lawsuit is bought against the individual or facility, the method provides litigation support in the form of references to legal counsel and expert written legal opinions on the proper jurisdictional standard of care on the use of an AED. For customers requiring additional assurance, the method offers an indemnification plan for the facility, the AED owner, and/or employees, and others, against whom claims regarding use of the AED might be filed. In such a case, the method coordinates with the individual's or facility's insurance carrier to ensure proper liability coverage. As an added benefit, a life insurance policy covering victims of SCA on/in the facility may be provided.

Throughout participation in the CER program, free consultation 108 by email or other means is provided to answer any questions or concerns related to the use of the AEDs or the program itself.

After purchasing the AEDs and implementing the CER program, the individual or facility is certified (118) as having met the standards of the program. The certification informs the public that the individual or facility has established an effective CER program that could potentially save lives.

The method depicted in FIG. 1 may be modified depending on the circumstances involved. For example, if the procedure for obtaining permits for the purchase and use of an AED is a long and protracted process, one could initiate this process before conducting an on-site survey to determine the number of AEDs needed. Also, training may be provided on AEDs that are loaned to the premises for the exclusive purpose of training, before the procurement of permits or the purchase of the AEDs. The CER program may also be implemented by current owners of AEDs. The program allows current owners to implement all aspects of the AED program, other than those related to the purchases of an AED, and certifies them as having met the standards set out in the program. Specifically, customers receive a certification seal, which clearly distinguishes the facility as being ready to deal with incidents of SCA.

In addition to the obvious tangible benefits of the CER program, there are several intangible benefits. Specifically, customers receive a certification seal, which clearly distinguishes the facility as being ready to deal with incidents of SCA, and assists in their branding efforts. Thus, the CER program provides an important service for individuals and companies to offer their patrons who will have the comfort of knowing that the site is capable of handling cardiac emergency situations. For example, hotels can market this service to their senior citizens, with the goal that senior citizens will choose their hotels, based in part, on the certification program. The benefits of the CER program may prompt many businesses to proudly display their certification seal.

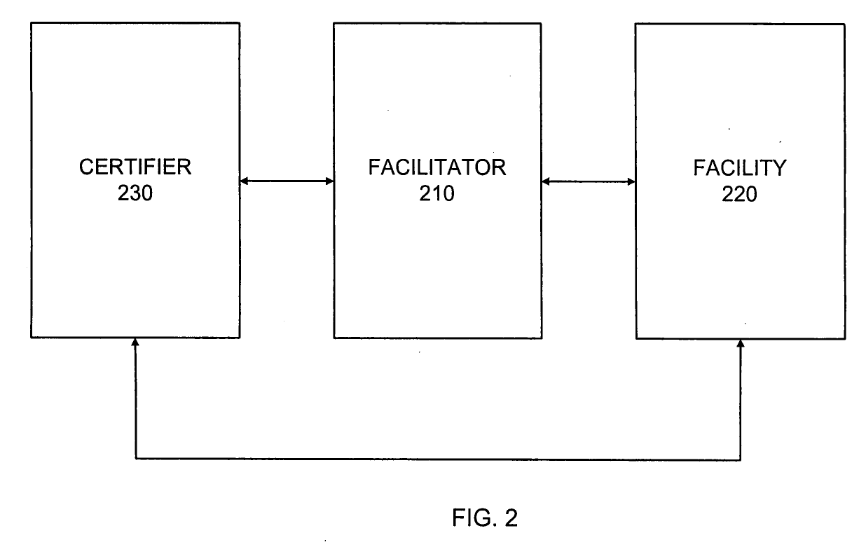

Referring to FIG. 2, entities that may be involved in the offer to certify, or otherwise designate, a facility, the certification process, and the promotion of a certified facility are shown. The entities may include a facilitator 210, a facility 220, and a designating or certifying entity, (certifier) 230. The facilitator 210, the facility 220, and the certifier 230 may each be equipped with, or employ, hardware and/or media for communication among themselves as described herein. In reference to FIG. 2, the facilitator 210 and the certifier 230 are shown as separate entities, but a single entity may perform both functions. In either event, the facilitator 210 and the certifier 230 cooperate to designate a facility 220 (that has previously accepted an offer from the facilitator) as having a certified CER program.

The certifier 230 is knowledgeable of, and has established standards or guidelines with respect to, existing regulations, laws, and requirements concerning the placement, training, use and maintenance of AEDs for use in connection with a CER program. The certification and services offered by the certifier 230 may be endorsed by a respected and well known agency in the appropriate medical field, and preferably one that is independent and respected, such as the American Heart Association®. If a facility 220 that has accepted an offer to become certified already has a CER program, then the certifier 230 determines if the facility's CER program satisfies the necessary standards or requirements for certification. However, if the facility 220 does not presently have a CER program, then certifier 230 advises the facility of the steps it needs to undertake to become certified. The facilitator 210 may serve as a “middle-man” between the facility 220 and the certifier 230 and may provide the certifier's certification standards or requirements to the facility 220.

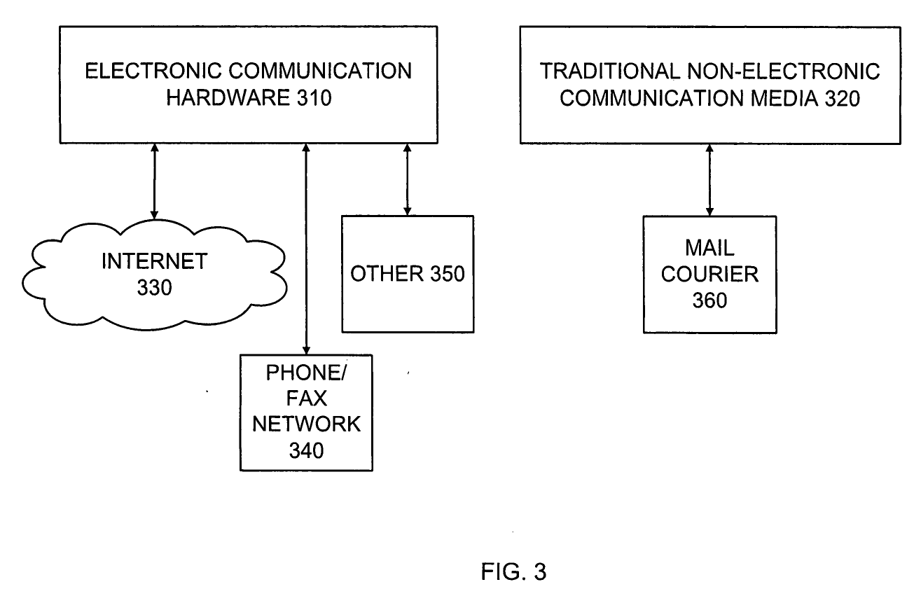

FIG. 3 illustrates the various hardware and/or media that may be employed by each of the entities 210, 220, 230 to communicate among themselves in the manner described herein. As shown, the communications may occur or be facilitated by way of electronic communications hardware 310 (e.g., a personal computer or fax device) that employs the internet or other wide area network 330, a phone/fax network 340, a wireless communications network, including, for example, a cell phone network. Electronic media 350 such as email messaging, instant messaging, voice communications, voicemail messaging, fax, posting to a web site, etc. may be employed for communications. Alternatively, traditional non-electronic media 320 (e.g., letters, mailers, flyers,) typically hand delivered by a courier 360 or other person may be employed.

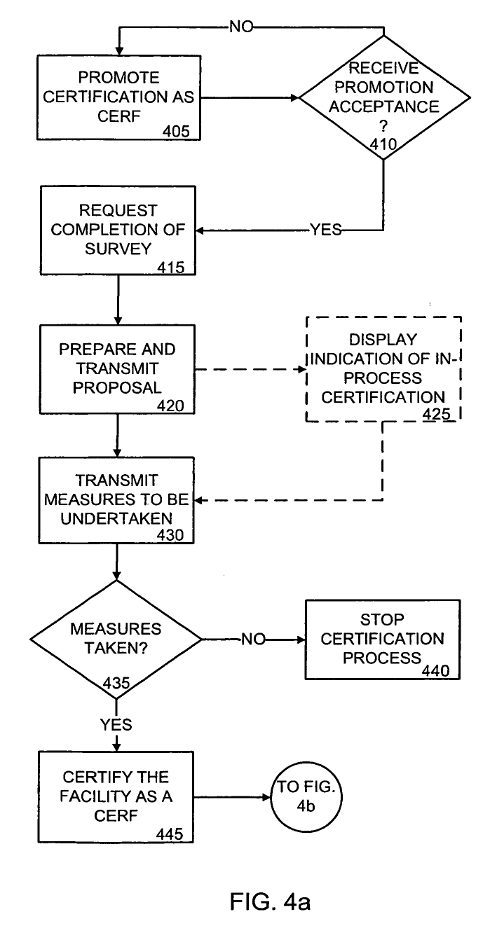

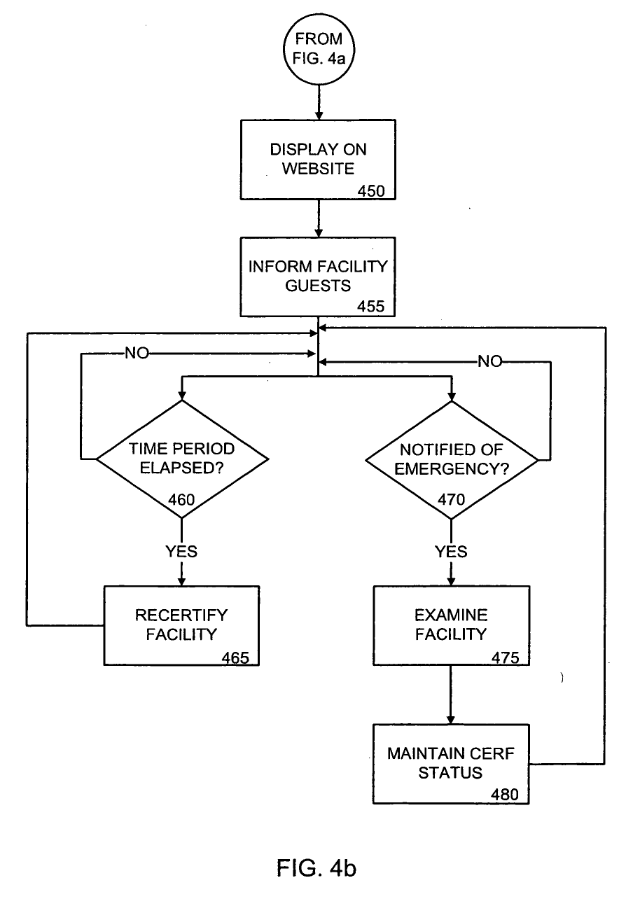

One method of implementing the offering, certification and promotion process is shown in FIGS. 4a and 4b. As shown at 405, the method may begin with the transmission of a promotion to the facility 220 to establish a CER program and become certified and/or to have its existing CER program certified, in which case the facility becomes a certified or otherwise designated cardiac emergency ready facility (“CERF”). The promotion preferably originates from facilitator 220, and is communicated to facility 220 by one of the media means described above. Thus, the promotion may be communicated through an internet advertisement, a text message, an email message, a facsimile, a voice communication, a voice mail message, regular mail, or a combination thereof. However, the promotion may originate elsewhere, including, for example from certifier 230; the certifier may communicate directly with the facility. The promotion may identify advantages for the facility 220 to establish a CER program and become certified or to have its existing CER program certified.

As shown at 410, the facility 220 may accept, reject or ignore the promotion. The acceptance of the promotion from the facility may be in the one of same forms discussed above. As shown, the facilitator 210 may later reissue the promotion if it was previously rejected or ignored, or the facilitator 210 may decide not to reissue the promotion after it has been issued a predetermined number of times or after a predetermined time period has elapsed. If the facility 220 accepts the promotion, then the facilitator 210 may request the facility 220 to respond to an inquiry which may be in the form of an initial survey. The purpose of the inquiry or initial survey is to determine the facility's physical and other characteristics relating to placement, use, training, etc. of AED's, and to allow the certifier 230 to ascertain what steps, if any, the facility needs to undertake to become certified, i.e., to have its existing CER program designated or certified. The characteristics of the facility 220 may include, among other things, the size of the facility 220, the number of rooms of the facility 220, the location of stairwells and exit points at the facility 220, the number of users (e.g., customers, guests or employees) of the facility, and, if the facility already has a CER program, the details of the CER program.

As shown at 420, based upon the answer to the inquiry or the completion of the initial survey, the facilitator 210 may prepare and transmit a proposal to the facility to become certified. Alternatively, the proposal may be prepared by the certifier 230. The proposal may take into account the characteristics of the facility 220 in conjunction with the certifier's (230) certification requirements. The proposal may include a cost estimate for certifying the facility 220 (or the facility's existing CER program), a cost estimate for the required AEDs, the number of employees or facility personnel to be trained in the use of the AEDs, etc.

As shown at 430, if the facility 220 accepts the proposal, then the facilitator 210 may transmit measures to be undertaken by the facility 220 in order to satisfy certification standards or requirements. In addition, at 425, before or concurrent with the transmission of the measures to be undertaken, an indication that the facility 220 is in the process of becoming certified may be displayed on a web site or other means that is used to search for a facility, as further described below. The measures to be undertaken by the facility 220 to become certified may be identified on a checklist to be completed by the facility 220. The checklist may be provided by the certifier 230, the facilitator 210, or both the certifier 230 and the facilitator 210. The measures to be undertaken (and indicated on the checklist) may include but are not limited to the following: the identification of a facility coordinator; the development of an emergency response plan to be used in the event of a cardiac emergency; the placement in the facility of AEDs and/or other cardiac emergency equipment; the provision of training to facility personnel; the testing and maintenance of the AEDs and/or other cardiac emergency equipment; and means for notifying users of the facility that the facility has a certified CER program.

As shown at 435, the checklist as completed by the facility 220 is forwarded to certifier 230, either directly by the facility 220 or via the facilitator 210. The completed checklist is used by the certifier 230 to determine if the measures necessary to become certified have been satisfactorily undertaken by the facility 220. As shown at 440, if the required measures have not been satisfactorily undertaken, then the certification process may terminate, and the certifier 230 may not certify the facility 220 or its CER program. In this case, the process either terminates or the facilitator and/or certifier work with the facility to satisfy the required measures. If, on the other hand, the measures have been satisfactorily undertaken as demonstrated by the latest checklist, then, as shown at 445, a certification is issued by the certifier 230 indicating that the facility 220 has a certified CERF. Where the facility meets the standards for certification as demonstrated by completion of the initial survey, no measures will need to be undertaken at 435.

Once the facility's CER program has been certified, as shown at 450, an indication to this effect is displayed on a media frequented and examined by users (e.g., persons such as customers and guests) of the facilities. For example, the certifier 230 may inform the facilitator 210 of the certification of the facility 220, and the facilitator 210 may accordingly cause an indication that the facility 220 is a certified CERF to be displayed on the media. The media can be magazine, television, or internet advertising, to name a few.

In one embodiment, the facilitator is a reputable and well known entity commonly used by event or meeting planners (and others) to book events or meetings at various event and meeting facilities (e.g., convention centers and hotels) with whom the facilitator acts as a “middle-man”, and the indication is displayed on media or a data base which is readily searchable and associated with the facilitator. In this manner, event and meeting planners and others can readily identify and/or search the data base and ascertain the identity of the certified CERFs The data base may include a page for each facilities in the data base and the page for a facility which is a certified CERF will so indicate. The indication may advantageously be provided on a website operated by the facilitator that is used by event and meeting planners (and others) to determine the availability of facilities and to book events at a facility. The facilitator 210 may be responsible for the content on the website or may provide the information necessary to update the website to another party. One example of such a facilitator is OnVantage.com (www.onvantage.com).

As shown at 455, users of the facility 220 may be informed that the facility has a certified CER program. For example, the guests may be informed directly by the facility 220 when making a reservation at the facility 220, upon arrival at the facility 220, at a time before arrival at the facility 220, and/or by means of a plaque or signage at the facility. Guests of the facility may also have been informed of the facility's certification from the display in the media discussed above.

Subsequent to the initial certification, it may be necessary to recertify the facility's CER program. For example, the certifier 230 may need to recertify the facility 220 at predetermined time intervals, e.g., once every year or every other year or as otherwise required by industry standard or law (as shown at 460 and 465), or upon notification of an occurrence of a cardiac emergency at the facility (as shown at 470, 475 and 480). The recertification process may be similar to or the same as the original certification process (e.g., including a new survey to be completed), or may be a subset thereof, or may involve an in person inspection and survey by the facilitator 210 and/ or the certifier 230. If the certifier 230 determines that the appropriate recertification measures have been taken, then the certifier 230 recertifies the facility 220. The recertification process may also include causing an indication that the facility 220 has been recertified to be displayed on the media discussed above. With particular reference to the event of a cardiac emergency (470, 475 and 480), the occurrence of a notification of an emergency may be determined and/or evaluated. The facility 220 may report to the facilitator 210 a cardiac emergency occurrence involving the use of the cardiac emergency equipment, who may relay the notice to the certifier 230, or the facility 220 may directly report the cardiac emergency occurrence to the certifier 230 (see 470). As shown at 475, if a cardiac emergency occurs at a certified facility 220, the certifier 230 examines or audits the facility 220. The examination or audit of the facility 220 may be performed in order to determine the effectiveness of the certification, such as for example whether the training of the facility personnel or the placement of equipment was sufficient. In addition, the examination or audit of the facility 220 may indicate that additional measures should be undertaken by the facility 220 in order to maintain its certification. For example, the certifier 230 may determine that additional training is necessary or that additional AEDs are required. Or, the examination may reveal that the only necessary remedial measure is to maintenance or replacement of the AED used during the cardiac emergency incident. Any additional measures required to be undertaken to maintain certification may be indicated in a post-emergency checklist. The facility 220 may complete the items, required by the certifier 230 and noted on the post-emergency checklist, and may provide a completed post-emergency checklist to the certifier 230. The certifier 230 may then examine the post-emergency checklist and determine if the appropriate measures have been taken by the facility 220. If the additional measures have been taken, then the certifier 230 maintains the certification of the facility 220.

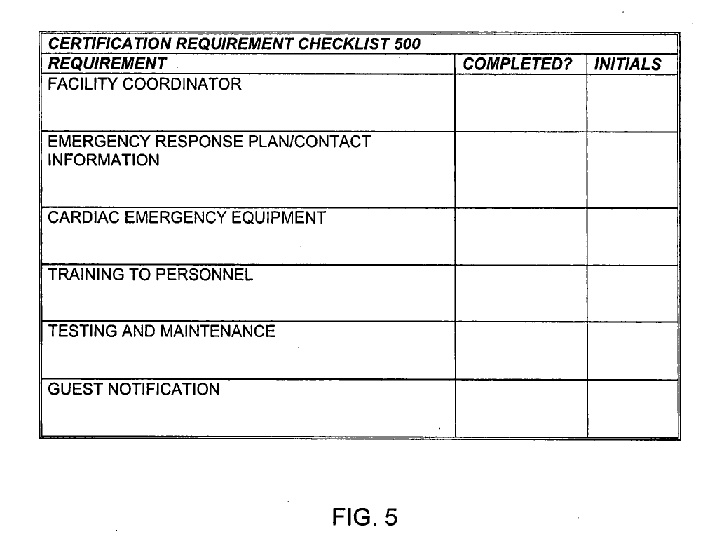

FIG. 5 illustrates an exemplary checklist 500 that may be used in connection with the certification and re-certification methods, and/or in connection with a cardiac emergency event, described above. As shown, the checklist may include a list of requirements to be satisfied by the facility 220. The requirements may include but are not limited to: the existence of a designated facility coordinator; the existence of an emergency response plan/contact information; the existence of satisfactory cardiac emergency equipment; and, whether the requirements of personnel training, equipment testing and maintenance, and user notification (e.g., guest notification in the case of the one preferred embodiment) have been satisfied. A column is provided so that a person associated with the facility responsible for addressing the requirements (e.g., facilities manager) can indicate whether each requirement has been satisfied by placing his/her initials in the “Completed” column. A column is also provided to allow the certifier 230 to indicate if each requirement has been satisfactorily addressed. Although not shown, the checklist may also include an indication of the number of AEDs, locations of those AEDs and the maximum distance and/or tround trip wlking time to an AED at any location within the facililty. The checklist may also be modified to address differences in procedure between original certification and re-certification, and procedures following a cardiac emergency incident.

The following provides additional detail that might be included in the checklist:

Emergency Response Plan

Use of AEDs included in plan
Physician Oversight—Contact Info—Name, Address, Tel, E-mail
Communication with local emergency entities—Contact info—Org, Name, Address, Tel, E-mail
   Hardware
Proper number and placement of FDA-approved, biphasic, AEDs according to the following specifications. From any point within the building, at least one AED should be close enough to retrieve and be at an SCA victim's side within 3 to 4 minutes. Assume average walking speed of 4.75 feet per second.
   Within 400 ft if on same floor, or accessible by stairs/escalator
   Within 250 ft. if elevator is required to reach AED.
   Reduce distance by an additional 15 ft. for each additional floor traveled one-way via elevator
Each AED is to be publicly accessible and housed in a recessed or surface mounted wall cabinet including alarm entry with on/off position and acrylic door.
   Testing and Maintenance
AED-Test unit and replace battery, pads, and other consumables according to manufacturer's required schedule.
Wall Cabinet-Test unit and replace battery, and other consumables according to manufacturer's required schedule.
Recording and monitoring of monthly rescue readiness testing. Training
At least six (6) employees with current certifications in CPR including AED use for each AED installed for the first 10 AEDs with at least three (3) employees with current certifications in CPR including AED use for each AED above 10.
Train additional employees to compensate for turnover and reassignment.
   Modifications to the Plan following Certification
Client is to notify certifier should hotel renovations and/or modifications alter the path/distance from an area to an AED causing it to be beyond the specified distance from an AED.
Client is to notify certifier in the event of changes to the client's business or personnel.
Certifier to advise the client of any changes to the number or placement of the AEDs and/or staffing requirements as a result of changes to the client's business or personnel or as a result of changes in the law, regulations, best practices or changes in the standard of care required for certification. For each change, client will be notified of the timeframe to complete in order to maintain certification status.
compliance with state and federal statutory and regulatory requirements
Assures compliance with the guidelines recommended by relevant authorities such as the American Heart Association.
   Per Incident Support
   Event documentation and report as required by local jurisdictional accepted mandate. Personnel debrief and education. Rescue readiness restoration of equipment.

As discussed above, the term “certified” has been used in connection with those facilities who have met certain standards or requirements for a CERF. However, it is possible that various levels of standards or requirements may be satisfied providing various degrees of facility readiness for a cardiac emergency. It is intended that the term “designation” includes various levels whether or not it rises to the level of “certification”. For example, a facility meeting a lesser standard might be designated as “registered” rather than “certified”. The term “designation” as used herein is intended to embrace any and all “designations” where the nomenclature used represents some standards or requirements of readiness for a cardiac emergency at a facility having AEDs.

The foregoing examples have been provided for the purpose of explanation and are in no way to be construed as limiting, except as expressly set forth in the appended claims. While the invention has been described with reference to various embodiments, it is understood that the words which have been used herein are words of description and illustration, rather than words of limitation. Further, although the embodiments have been described herein with reference to particular means, materials, and examples, the embodiments are not intended to be limited to the particulars disclosed herein; rather, the embodiments extend to all functionally equivalent structures, methods and uses, such as are within the scope of the appended claims.

What is claimed:

1. A method of providing a cardiac emergency readiness program at a facility comprising:
conducting a survey of the facility for determining the proper placement of at least one automatic external defibrillator so as to assure a predetermined proximity to a defibrillator by any victim of sudden cardiac arrest at the facility;
certifying that the cardiac emergency readiness program has met certain minimum requirements including the proper placement of the at least one automated external defibrillator in accordance with the survey; and
providing ongoing support for the cardiac emergency readiness program including the promotion of the facility as having a certified cardiac emergency readiness program through a communication network.

2. The method of claim 1 wherein facility personnel conduct the survey.

3. The method of claim 1 further comprising:
placing the at least one automatic external defibrillator in accordance with the survey.

4. The method of claim 3 wherein facility personnel conduct the survey and place the at least one automated external defibrillator.

5. The method of claim 1 further comprising:
selecting facility personnel to be responsible for the cardiac emergency readiness program.

6. The method of claim 1 further comprising:
maintaining the at least one automatic external defibrillator.

7. The method of claim 6 wherein facility personnel maintain the at least one automatic external defibrillator.

8. The method of claim 1 further comprising:
training facility personnel to use the at least one automated external defibrillator.

9. The method of claim 1 wherein the step of providing ongoing support includes the maintenance of a checklist including the name of the person responsible for the cardiac emergency readiness program and the number of automatic external defibrillators.

10. The method of claim 9 wherein the checklist is completed by facility personnel.

11. A cardiac emergency readiness designation method comprising:
transmitting to a facility a request to complete a survey relating to automatic external defibrillators and the associated cardiac emergency readiness program characteristics of the facility;
receiving from the facility the survey as completed describing the cardiac emergency readiness program of the facility;
determining if measures have been taken by the facility to meet the requirements for designation as a cardiac emergency ready facility;
if the requirements have been met, causing the facility to receive a designation as a cardiac emergency ready facility; and
causing to be displayed to the public an indication of said designation for the facility.

12. The method of claim 11 further comprising:
transmitting an inquiry from a facilitator to a facility as to the characteristics of the facility; and
based on the answer to the inquiry, transmitting from the facilitator to the facility a proposal to designate the facility as a cardiac emergency ready facility including the cost therefore.

13. The method of claim 12 wherein the inquiry is an initial survey.

14. The method of claim 12 wherein the proposal to designate includes the costs of measures to be undertaken at the facility in addition to the cost to designate.

15. The method of claim 11, further comprising:
transmitting from the facilitator to the facility a promotion for the facility to become a designated cardiac emergency ready facility.

16. The method of claim 11, wherein the measures to be undertaken comprise one or more of (i) identifying a facility coordinator; (ii) developing an emergency response plan to be used in the event of a cardiac emergency; (iii) placing in the facility automatic external defibrillators; (iv) providing training to facility personnel; (v) testing and maintaining the automatic external defibrillators; and (vi) notifying users of the facility that the facility is a designated cardiac emergency ready facility.

17. The method of claim 11, wherein the determination that the measures have been taken comprises confirming that the facility has completed a checklist satisfactorily indicating that it has met the requirements to become a designated cardiac emergency ready facility.

18. The method of claim 11, further comprising causing the facility to be re-designated after a predetermined period of time.

19. The method of claim 11, further comprising causing the facility to be examined or audited for on-going compliance with the designation requirements after the occurrence of a cardiac emergency at the facility.

20. The method of claim 19, further comprising:
upon examination or audit of the facility, causing to be transmitted additional measures to be undertaken by the facility to maintain the status as a designated cardiac emergency ready facility; and
based upon a determination that the additional measures have been taken, continuing the status as a designated cardiac emergency ready facility.

21. The method of claim 11, wherein the step of causing to be displayed to the public comprises causing said indication of designation of the facility to be displayed along with similar indications of designation for other facilities and providing a searchable database of designated facilities.

22. A cardiac emergency readiness designation method comprising:
accepting a promotion to become a designated cardiac emergency ready facility employing at least one automatic external defibrillator;
completing a survey received from the facilitator relating to characteristics of the facility;
upon review of a proposal to become a designated cardiac emergency ready facility, accepting the proposal from the facilitator;
performing measures necessary to become a designated cardiac emergency readiness facility; and
agreeing to allow the facilitator to display to the public an indication that the facility is a designated cardiac emergency ready facility.

23. The method of claim 22, further comprising indicating at the facility that the facility is a designated cardiac emergency ready facility.

24. The method of claim 22, further comprising performing redesignation measures to be redesignated as a cardiac after a predetermined period of time.

25. The method of claim 22, wherein performing measures necessary to become designated as a cardiac emergency ready facility comprises completing a checklist indicating that requirements to be designated have been satisfied.

26. The method of claim 22, further comprising:
reporting the occurrence of a cardiac emergency at the facility; and
indicating that measures to continue the facility's status as a designated cardiac emergency facility have been undertaken.

27. The method of claim 22, wherein the step of causing to be displayed to the public comprises causing said indication of designation of the facility to be displayed along with similar indications of designation for other facilities and providing a searchable database of designated facilities.

28. A cardiac emergency readiness designation method comprising:
determining, from a survey completed by a facility relating to characteristics of the facility, measures to be undertaken by the facility to become a designated cardiac emergency ready facility employing at least one automatic external defibrillators;
causing to be transmitted to the facility the measures to be undertaken by the facility to become a cardiac emergency ready facility;
determining if the measures have been taken by the facility;
based upon a determination that the measures have been taken, designating the facility as a cardiac emergency ready facility; and
displaying to the public an indication that the facility is designated as a cardiac emergency ready facility.

29. The method of claim 28, wherein determining if the measures have been taken by the facility comprises confirming that the facility has completed a checklist satisfactorily indicating that it has met the requirements to become designated as a cardiac emergency ready facility.

30. The method of claim 28, further comprising:
after a predetermined period of time, determining if any redesignation measures need to been undertaken by the facility;
based upon a determination that any measures needed for redesignation have been taken, redesignating the facility as a cardiac emergency ready facility.

31. The method of claim 30, further comprising:
upon notification of an occurrence of a cardiac emergency, causing to be transmitted to the facility any additional measures needed to be undertaken by the facility to remain designated as a cardiac emergency ready facility;
determining if the additional measures have been taken by the facility; and
based upon a determination that the additional measures have been taken, continuing to designate the facility as a cardiac emergency ready facility.

32. The method of claim 28, wherein the step of causing to be displayed to the public comprises causing said indication of designation of the facility to be displayed along with similar indications of designation for other facilities and providing a searchable database of designated facilities.

33. A cardiac emergency readiness designation method comprising:
transmitting to a facility questions as part of a survey relating to characteristics of the facility;
based on the answers by the facility as part of the survey, transmitting to the facility a proposal to designate the facility as a cardiac emergency ready facility employing at least one AED including any necessary measures needed to be undertaken to satisfy standards for designation;
based upon a determination that the measures have been undertaken for designation, causing the facility to be designated as a cardiac emergency ready facility; and
causing to be displayed to the public an indication that the facility is a designated cardiac emergency ready facility.

34. The method of claim 11 wherein the step of causing an indication to be displayed on a website comprises causing the indication to be displayed on a website.

35. The method of claim 22 wherein the step of causing an indication to be displayed on a website comprises causing the indication to be displayed on a website.

36. The method of claim 28 wherein the step of causing an indication to be displayed on a website comprises causing the indication to be displayed on a website.

37. The method of claim 33 wherein the step of causing an indication to be displayed on a website comprises causing the indication to be displayed on a website.
